(19) United States
(12) Patent Application Publication
(10) Pub. No.: US 2013/0061692 A1
(43) Pub. Date: Mar. 14, 2013

(54) ELECTRONIC NOSE APPARATUS

(71) Applicants: Radu Muresan, Guelph (CA); Ngamta Muresan, Guelph (CA)

(72) Inventors: Radu Muresan, Guelph (CA); Ngamta Muresan, Guelph (CA)

(73) Assignee: MURESAN ENTERPRIZE, Guelph (CA)

(21) Appl. No.: 13/595,849

(22) Filed: Aug. 27, 2012

Related U.S. Application Data
(60) Provisional application No. 61/527,373, filed on Aug. 25, 2011.

(51) Int. Cl. G01N 1/00

(52) U.S. Cl. 73/863

(57) ABSTRACT

A pumpless electronic nose sensing apparatus includes a cavity for holding a volume of the sample to be tested, and a port disposed on an outer wall of the cavity for enabling transfer of the sample into the cavity. A precise, controllable air current assembly is operatively connected to the cavity for producing an air flow within the cavity for uniformly distributing the sample. The air current assembly is expansible, and by axial expansion and contraction of the air current assembly in response to a load applied to an axial end thereof an air flow is created within the cavity. An at least one sensor array disposed within the cavity is used to test the sample and produce an output. By operative association with the expandable air current assembly, the cavity itself is indirectly expandable (and contractible) in response to the expansion and contraction action of the air current assembly.

This application claims priority to U.S. Provisional Patent Application No. 61/527,373 filed on Aug. 25,2011.

### FIELD OF THE INVENTION

The present invention relates to electronic nose systems, and, in particular, to electronic nose devices for use in identifying and characterizing gas compounds.

### BACKGROUND OF THE INVENTION

The market for electronic nose technology is increasing steadily and based on various business predictions the global production of electronic nose technology is in the order of hundreds of millions of dollars. The electronic nose mimics the functions of the human olfactory system and generates a digital signature that characterizes a complex odor as a whole. The digital signature as a whole is a function of the odor's individual components (e.g. type and quantity). As a result, the identification of odors and quantization of compounds within odors is possible.

Unlike other analytical techniques such as gas chromatography where individual compounds of the gas are identified, the electronic nose classifies the odor as a whole and shows the synergy of the compounds in a single olfactory image. Since its development, electronic nose technology has been applied to many industrial and experimental fields such as food and beverages, spirits production, cosmetics, environmental monitoring, medical diagnosis, and industrial robots. In these applications, the e-nose system identifies a complex odor typically by using an array of gas sensors, a signal processing module, a data acquisition module and a pattern recognition algorithm.

The largest commercial market for electronic noses is the food and beverage industry where the electronic nose devices can augment at replace current methods of quality control based on gas chromatography and human experts. Gas chromatography is expensive and time consuming while human experts are subjective and lack consistency. Electronic noses are currently employed for quality grading of food by odor, fermentation control, automated flavor control, beverage container inspection, etc. It is also worthy of note that one of the industries that has always been active in electronic nose technology development is the wine industry.

As a result of this widespread demand, there are currently various types of commercial electronic-nose systems available from different companies that use array combinations of sensors and build various features. For example, one such system uses a matrix of chemical, non-selective sensors (quartz crystal microbalance). Typical applications of this system are in food industry, health, environmental monitoring and industrial process control. Besides the development of commercial type e-nose systems, there is continuous research that targets the development of portable e-nose systems that seek to improve the sensor array structure and the pattern recognition algorithms. Most of the portable electronic devices that are commercially available target indoor air quality, poisonous gas detection, smoke detection, biohazard materials detection, etc.

Regarding gas sensors that can be used for specialized electronic nose applications, the general principle by which such sensors function is based on the interaction of the gas molecules with the solid-state sensor material (thin or thick films) through phenomena such as absorption, adsorption or chemical reactions. This interaction produces physical changes that can be measured as an electrical signal. Typical physical changes encountered in the gas sensor active film are conductivity (conductivity sensors), mass (piezoelectric sensors), optical (optical sensors), and work function (MOSFET sensors). Common conductivity sensors include conducting polymer (CP) composite sensors and metal oxide sensors (MOS). Common piezoelectric sensors include surface acoustic wave sensors (SAW) and quartz crystal microbalance (QCM) gas sensors.

Pattern recognition algorithms are also essential to the process of complex odor identification. Pattern recognition algorithms combined with gas sensor arrays can address some of the shortcomings of individual gas sensors (i.e., lack of selectivity, sensitivity, nonlinearities of sensors' response, and long-time drift). The principal goal of the pattern-recognition technique is to find a relationship between the sensors' outputs and the odor class.

Electronic nose technology has notable application in the food and beverage industry, both in the production process and for quality assurance purposes. Research in this area deals with general studies such as the classification of wines of different varieties and the discrimination of coffee flavors of different varieties but do not address some of the more applicable problems such as the study of differences occurring among products. An application of electronic nose technology for this purpose would benefit the production process. There has also been little research targeting spirits brewing, particularly quality assurance and off flavor identification. Specifically, a suitable e-nose apparatus must be capable of identifying varieties of distilled spirits and assessing aging of distilled alcoholic beverages in wooden barrels.

Importantly, one of the main challenges for the development of a portable e-nose apparatus is the fact that most of the low cost volatile organic compound (VOC) sensors (i.e., the MOS gas sensors) saturate at high concentrations of VOC. In fact, MOS gas sensors have the optimal detection concentration of VOC in the range of 50 ppm˜5000 ppm (parts per million). In order to overcome this problem and still use MOS type commercial gas sensors in a single, portable apparatus one must be able to control the maximum allowable concentrations within the measurement chambers.

Prior art portable devices for gas sensing that use non-selective gas sensors are generally complex and have various limitations as aforedescribed. Further, such devices are generally not suitable for the development of selective gas classifier algorithms, and present lower reliability and high power consumption.

### SUMMARY OF THE INVENTION

The present invention relates to a portable electronic nose (e-nose) sensing apparatus which mimics the human olfactory system. In one embodiment, the apparatus of the present invention includes an interior cavity for holding a volume of the gas or liquid sample to be tested, and a port disposed on an outer wall of the cavity for enabling transfer of the sample into the interior cavity. A precise, controllable air current assembly is operatively connected to the interior cavity for producing an air flow within the interior cavity for the purpose of uniformly distributing the sample prior to (or during) testing. The air current assembly includes a flexible body portion which is expandable and by axial expansion and contraction of the air current assembly in response to a load applied to an axial end thereof in order to create an air flow within the interior cavity. An at least one sensor array disposed within the interior cavity is used to test the sample and produce an output for further processing. A processor in signal communication with each of the at least one sensor arrays receives the output from and controls operation of each of the sensor arrays. By operative association with the expandable air current assembly, the cavity itself is indirectly expandable (and contractible) in response to the expansion and contraction action of the air current assembly. By precisely controlling the operation of the air current assembly, the apparatus is readily adaptable for use in testing samples having distinct physical properties, and the need for use of interchangeable sensing chambers (of differing volumes) is obviated.

In another embodiment of the present invention there is described an apparatus for measuring properties of a liquid or gas sample, the apparatus including a plurality of sensing cavities for holding a volume of the sample, each of the sensing cavities comprising an at least one sensor array for measuring properties of the sample and producing an output, wherein each of the sensing cavities is in fluid communication with each of the other sensing cavities. An at least one access door is disposed on an outer wall of at least one of the sensing cavities, for enabling deposit of the sample into the interior cavity. Further, a membrane filter is disposed between each of the at least one sensing cavities. Each membrane filter is used to selectively filter one or more compounds from the sample. An air current assembly is operatively connected to the interior cavity. The air current assembly comprises an expandable body portion for producing an air flow within the interior cavity, to uniformly distribute the sample, by axial expansion and contraction of the body portion in response to a load applied to an axial end thereof. A processor in signal communication with each of the at least one sensor arrays receives and processes the output.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is a schematic diagram of the apparatus of the present invention.

FIG. 2 is a schematic diagram of an alternate embodiment of the apparatus of FIG. 1.

FIG. 3 is a schematic diagram of yet another alternative embodiment of the apparatus of FIG. 1.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION

All terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, it will be appreciated by those skilled in the art that other variations of the preferred embodiments described below may also be practiced without departing from the scope of the invention.

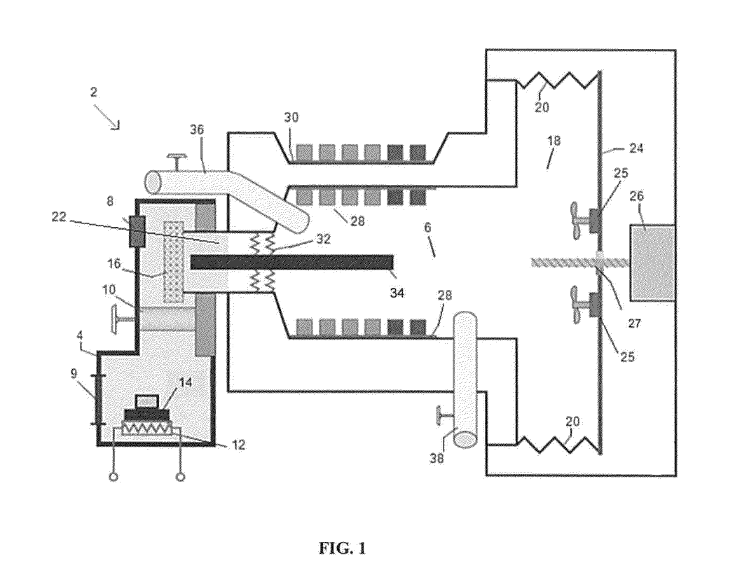

The apparatus of the present invention takes the form of a mechatronic system that mimics the structure of the human olfactory system in an attempt to mimic the mechanism and function of the human smelling sense. Referring to the drawings, and initially to FIG. 1, there is shown at reference numeral 2 an embodiment of the electronic nose apparatus of the present invention. As shown in FIG. 1, a gas sample chamber 4 is sealingly engaged to a first cavity 6. The gas sample chamber 4 holds a volume of the gas to be measured by the apparatus 2. Optionally, the gas sample chamber 4 is detachable from the apparatus 2 such that the chamber 4 could be detached from the apparatus 2 after measurement of the gas has taken place. A gas sample can be distributed into the chamber 4 by means of direct injection, for example, through an injection port 8. Additionally, the gas could be fed directly through a door 9 of the gas sample chamber 4 or a valve 10.

In order to facilitate the development of compound selective classifiers within the sample, the chamber 4 may be provided with a temperature controlled heater 12. Where a liquid sample is used, a disposable pad 14 is provided within the chamber 4. The disposable pad 14 is embedded with a controlled amount of the liquid sample. The liquid sample is heated in stages by the heater 12 until the sample is partially or completely evaporated. The use of such temperature controlled heater 12 allows for selective evaporation of the compounds that are part of the sample, and therefore aids in the development of compound selective classifiers occurring within the sample.

A filter 16, such as a blank filter or a carbon filter, may be provided within the chamber 4 for blocking selective compounds of the sample prior to entry into the first cavity 6. After each measurement, if needed, the gas sample chamber 4 can be air flushed or ventilated, for example by inclusion of an air flushing port 38 (not shown) before a new sample is inserted. Depending on the specificity of operation required, smell sensors, and/or temperature and humidity sensors may further be disposed within the chamber 4.

An expansible second cavity 18 is operatively connected to the first cavity 6 and preferably disposed at a distal end of the first cavity 6, such that the first cavity 6 feeds into the second cavity 18. The second cavity 18 includes a pumpless air current assembly 20 for producing an air flow within the first cavity 6 in order to draw the gas sample from the chamber 4 and into the first cavity 6. The air current assembly 20 generally comprises an expandable body portion which expands and contracts axially in response to a load applied to an axial end thereof. In one embodiment the body portion of the air current assembly 20 is in the form of an expansible bellows which expands and contracts axially in response to a load applied to an axial end thereof. The bellows are used to circulate the gas sample within the first 6 and second 18 cavities until a homogeneous mixture is obtained. On expansion of the bellows, air is drawn in the direction of the bellows from the gas sample chamber 4 into the first cavity 6. On contraction of the bellows, the gas sample within the first cavity 6 is forced in the opposite direction, away from the bellows. In its initial state, the second cavity 18 is in a contracted state. Through an initial expanding action, the bellows draws the gas sample through a port 22 disposed between the chamber 4 and the first cavity 6. By the action of the air current assembly 20, the gas sample will move back and forth within the first cavity 6 until steady state measurements are obtained.

The bellows may be comprised of any suitable medium resistant material such as polytetrafluorethylene (PTFE) or stainless steel. Other forms of bellows, such as metal edge welded bellows, may also be employed. The body portion of the air current assembly 20 preferably includes a back plate 24 at its distal end and flexible side walls emanating from the back plate (or optionally one flexible continuous side wall) in the direction of the first cavity 6. The back plate 24 supports an at least one fan 25 for the purpose of promoting the equal distribution of the gas sample throughout the first cavity, thereby promoting equal exposure of the sample to all sensors for better measurements. As an alternative to the use of an at least one fan 25, a standard pedal mixture (not shown) could be used. Of course, the at least one fan 25 need not be positioned on the back plate 24 itself, but rather could be placed at any suitable position within the interior of the first 6 or second cavity 18. Where a conventional stepper motor 26 is employed as the means to operate the air current assembly 20, a threaded shaft 27 of the stepper motor 26 is connected to and protrudes through the back plate 24 (or body portion), such that the back plate 24 will move back and forth axially within the second cavity 18 when a load is cyclically applied to and removed from the axial end of the back plate 24 by operation of the stepper motor 26, which results in the axial expansion and contraction of the bellows. The material composition of the air current assembly 20 must possess good media exposure characteristics without contamination. The advantage of using a stepper motor 26 to control the movements of the air current assembly 20 is that it has a high resolution with a small step allowing for precise control of the travel distance of the back plate 20 and ultimately of the capacity of the second cavity 18.

An at least one sensor array 28, composed of a plurality of sensors, is disposed within the first cavity 6, each sensor for measuring the different variety of compounds within the gas sample. The number of arrays is limited by power consumption design requirements. In a preferred embodiment, two identical sensor arrays 28 are disposed within the first cavity 6. Using multiple identical sensor arrays provides at least the following benefits; 1) fault tolerance methods for increased reliability can be employed; 2) enables a more accurate measurement of the sample is possible through the use of sensor array averaging methods; and 3) various error correction algorithms can be implemented. Each of the at least one sensor arrays 28 measures properties of the gas sample and produces an output, which is received by a CPU (central processing unit) or processor (not shown) in signal communication with each of the at least one sensor arrays, the processor for receiving the output and controlling operation of the at least one sensor array.

Optionally, a baseline sensor array 30 may be positioned on an exterior side of the apparatus 2 for measuring the air of the surrounding environment. By providing an environment baseline sensor array 30, differential measurements methods and error correction methods can be supported.

The plurality of sensors used in each of the at least one sensor arrays 28 can be of low-cost, non-selective commercial type gas sensors. For example, a hybrid structure array with a plurality of MOS, and/or MOSFET, and/or CP, and/or SAW and/or QCM, VOC gas sensors can be utilized. Ideally, each of the at least one sensor arrays 28 should be composed of at least four different gas target and/or sensor type gas sensors as well as one temperature sensor and one humidity sensor in order to increase compound selectivity and response. Many manufacturers use different sensing technologies that generate different responses. It has been shown that comparative methods using responses from more types of sensors provides better overall results. In a preferred embodiment, one sensor array 28 is positioned on an upper wall of the first cavity 6, and a second sensor array 28 is positioned on a lower wall of the first cavity 6.

It should be noted that there are various techniques such as temperature modulation and compound filtering that can be applied to the sensors and the gas sample in order to generate many virtual sensors from only a small number of physical sensors within each of the at least one sensor arrays 28. Since sensor performance improves at higher temperatures, a second heater 32 may be utilized to heat the first cavity 6. For each sensor, the temperature of MOS film affects the kinetics of the adsorption and reaction processes that take place within the sensor. Also, in the presence of multiple compounds, each will react preferentially as the temperature of the sensor varies. In the same way, the higher temperatures within the first cavity may impact compound separation from each gas sample and facilitate better selective response from the sensors. Since temperature impacts the measurements it is beneficial to be able to modulate and control the temperature of both the sensors and the first cavity itself. For this reason, additional heaters (not shown) may be associated with each sensor array 28.

On operation of the air current assembly 20 (e.g. expansion of the bellows), air is drawn from the gas sample chamber 4 into the first cavity 6 such that the sensors come in contact with the mixed gas. The back and forth movement of the bellows also causes a cyclical pressure variation within the first cavity 6. Also, if required, the bellows can be set to increase or decrease the pressure inside the interior cavity (being the first 6 and second cavity 18) of the apparatus 2, with the result being enhanced sensitivity response of the sensors.

Transient and steady state measurements will be recorded over long periods of time thus allowing for increased performance of the odor classifier algorithms. Some gas sample classifier algorithms use only steady state sensor responses. However, it has been shown that transient responses of sensors and temperature modulation of each sensor's heater increases the selectivity and the precision of the gas sample measurements. Gas sample mixture circulation, and as a result the homogeneity of the mixture, is controlled by adjusting the travel range and the travel speed of the back plate 24 through adjustments to the stepper motor 26. The homogeneity of the mixture is important in assuring equal exposure of the gas sample to all sensors of each sensor array 28. Again, this impacts the performance of the sensors in both qualitative and quantitative measurements.

Importantly, the apparatus 2 of the present invention enables an operator to precisely control the volume of the interior cavity (being the combined first 6 and second 18 cavities). This is accomplished by altering back plate travel range distances of the air current assembly 20 and start/end points on the shaft 27 of the stepper motor 26. Unlike other modular type e-nose sensor designs, the feature of an expansible sensing chamber (the interior cavity) enhances the adaptability the sensor device to different gas samples, without the need to provide multiple sensing modules and/or replace sensing modules in response to the particular gas sample to be tested. Indeed, in e-nose devices, the volume of the sensing chamber is critical in controlling the sensors' responses to the gas sample mixtures. Specifically, for low ppm (parts per million) gas sample concentrations, it is preferred to have a sensing chamber of low volume, while for high ppm gas sample concentrations, it is preferred to have a sensing chamber of higher volume.

In general, resistive type MOS sensors are connected in series with a reference resistor, both being placed between a fixed reference voltage Vref and ground. The signal from the sensor can be filtered of noise through a simple passive low-pass filter, then amplified, then connected to an analog to digital converter (ADC) for the purpose of conversion to a digital signal for further digital processing. The ADC can be external to a CPU (central processing unit) or processor (not shown) but preferably can be part of a CPU such as an internal ADC module within a microcontroller.

An optional separator 34 may depend from a wall of the first cavity 6 and be positioned between each of the at least one sensor arrays 28. The separator 34 allow for comparative measurements and possible selective transient filtering (for example, if a filter is placed one side of the separator, but not on the other. The separator 34 provides additional benefits, including that comparative secondary measurements can be extracted from the initial transient measurements which can then be further explored within the odor classifier algorithms by those skilled in the art. Further, controllable ON/OFF inlet 36 and outlet 38 tubes may positioned on the apparatus 2 in communication with the cavities 6, 18, to enable cavity flushing between measurements, and/or sample dilution via influx of clean air through the inlet 36. Combined with the controllable inlet 36 and outlet 38 tubes, the control of the bellows allows for dynamic change during measurements in response to feedback measurements.

Controlling the volume of the interior cavity of the apparatus 2 may increase sensor performance in both qualitative and quantitative measurements, including but not limited to volume control for adapting to different applications with different types of gas samples that might have different concentrations, thereby eliminating the need to substitute interior cavities (or sensing chambers) of different sixes; dynamic volume size control during measurements for increasing sensor sensitivity in response to some feedback signal; and volume control within the interior cavity for the purpose controlling the pressure within the interior cavity (whereby, for example, increased pressure within the interior cavity may aid sensor function).

The capacities of the first cavity 6 and the second cavity 18 depend on and must be designed based on the types of sensors used within each sensor array 28 and the type of target gases measured. However, it is possible to accommodate more applications with one general size. Also, the control of the second cavity 18 can allow for variable capacity of the first cavity 6, as a measurement chamber. In general, gas sensors have minimum and maximum compound exposure levels (given in ppm) for correct and reliable functionality. Different target gases have similar compounds present at various concentration levels. As a result, it is necessary to control the amount of gas that is fed into the sensing cavity (being the first cavity 6) for maintaining the minimum and maximum concentration levels. This can be done by diluting the samples, reducing the amount of the sample used, and by controlling the size of the first cavity 6. For fixed cavity sizes, in order to be able to accurately measure different samples it is important that fixed controlled amounts of samples are used.

The stepper motor 26 can be controlled through digital signals generated by a CPU (Central Processing Unit) (not shown), wherein the CPU is programmed to perform the data acquisition and signal conditioning for all of the sensors within each array 28; the control of any heaters, fans 25 and the stepper motor 26; the processing of the measurements; as well as all the interfacing of the apparatus 2 (i.e., human interface plus other communication interfaces). Known CPU microcontrollers are very powerful and contain large on-chip memories as well as analog to digital converter blocks and various on-chip devices. Ideally, the CPU board should be placed in a position on the apparatus 2 close to the sensor array 28 in order to minimize noise and signal interference. Candidates for the CPU microcontroller include FPGA based devices or general purpose low-power microcontrollers. The odor classifier algorithm and all of the embedded programming will reside within the on-chip flash memory of the microcontroller.

A fair number of pattern recognition methods have been introduced into electronic noses. For the purpose of the proposed e-nose apparatus proven artificial neural network (ANN) methods and fuzzy logic methods or a combination of both could be implemented. These algorithms are admittedly complex and require high performance processing capabilities. Current microcontrollers as mentioned above are very powerful and can support the implementation of these methods.

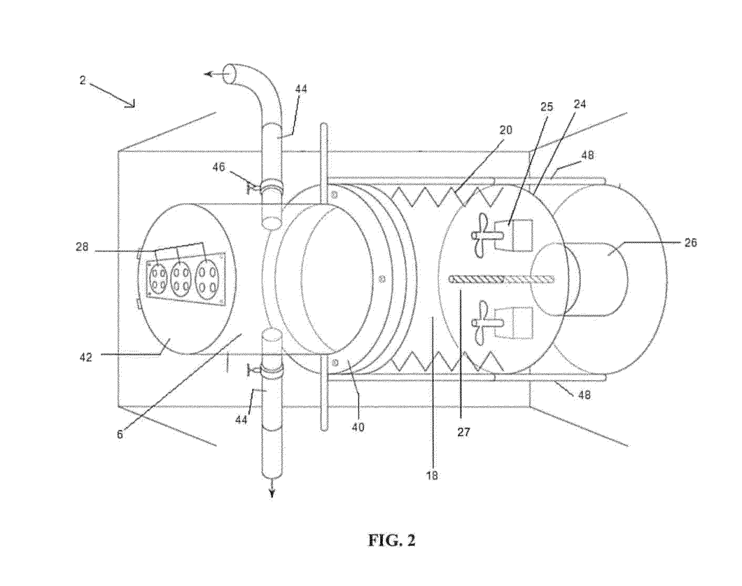

Referring next to FIG. 2, a schematic of an alternate embodiment of the apparatus of FIG. 1 is shown. In this embodiment, a practical design of the portable electronic apparatus 2 is present, which incorporates the same basic structural elements of the FIG. 1 apparatus, however, the gas sample chamber 6 is not shown. As depicted in FIG. 2, the apparatus 2 includes the two principal cavities, being the first cavity 6 and the second cavity 18, where the first cavity 6 is cylindrical in shape and feeds directly into the air current assembly 20 of the second cavity 18. The first cavity 6 is attached to the second cavity 18 by a connecting flange 40.

In the embodiment of FIG. 2, an access door (or port) 42 is disposed on a distal end of the first cavity 6. The sensor array 28 can be mounted directly on the access door 42 in order to enable ready access by an operator of the apparatus 2, for example, in order to allow the operator to easily reach each sensor, and related electronic components, of the array 28 for the purpose of repairing same. The structure and the designation of the sensor array 28 are the same as those described previously. The access door 42 can also be used for flushing (e.g. ventilation) the first and second cavities 6, 18 of the apparatus 2, thereby obviating the need for separate flushing tubes. In general, the sensors need to be calibrated periodically and the measurement chamber needs to be brought to its zero level measurement that is the baseline before performing a new measurement. Many MOS sensors have a reference measurement (i.e. baseline) that is produced when exposed to clean air. As a result, if the apparatus 2 is used in a contaminated environment, in order to perform accurate, repeatable and reproducible measurements all the chambers need to be zeroed (i.e. baselined) prior-to performing a new sample measurement. The apparatus 2 of FIG. 2 further includes an at least one tube 44 which connects into the first cavity 6 for the purpose of feeding a gas sample into the first cavity 6 for measuring, and optionally for air controlled sample dilution, or baseline flushing before and/or after measurement is complete. Each of the at least one tubes 44 is fitted with a valve 46 (e.g. manual or electric) for enabling the operator to control the flow rate within the tube 44 and open/close function. Where two tubes 44 are used, one tube 44 can function as an inlet tube, and the other tube 44 as an outlet tube. As further illustrated in FIG. 2, the back plate 24 of the air current assembly 20 is fitted in sliding engagement with an at least one stabilizing rod 48 at an at least one side of the back plate 24, such that the back plate 24 is supported by each stabilizing rod 48 as the back plate 24 moves back in forth in response to the axial load applied by operation of the stepper motor 26.

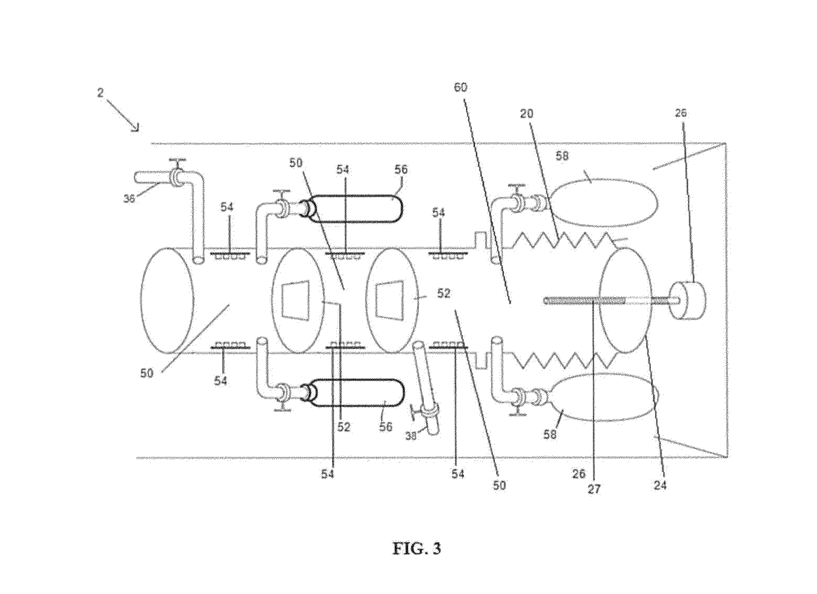

As depicted in FIG. 3, the apparatus 2 can be presented as a more complex design that includes a plurality of sequential sensing cavities 50 (i.e. at least two cavities) separated from each other by membrane filters 52, wherein each sensing cavity 50 contains an at least one sensor array 54. As illustrated in FIG. 3, the apparatus 2 also contains at least one high pressure detachable cylinder 56 filled with a baseline mixture such as aero air or other suitable mixtures and at least one detachable pressure equalization flexible (expending/compressing) cylinder (balloon) 58. The high pressure cylinders 56, 58 must be small and light in order to be suitable for use in taking remote measurements. When used in the lab, these cylinders can be replaced with other sources of baseline mixtures. The pressure equalization cylinders 56 serve to compensate for the pressure differences created by the back and forth movements of the air current assembly 20 and to reduce the external or internal pressures exercised on the air current assembly 20.

The pressure equalization cylinders 58 could be built from soft flexible aluminum or other materials such as the ones used in flying balloons. Where measurements are performed in contaminated environments or if measurements are performed one after another there is a need to bring the measurement chamber(s) to a zero (baseline) level measurement before an accurate new sample measurement is possible. As a result, each baseline cylinder 58 contains a mixture (preferably clean air) to bring the sensor array 54 responses to their baseline level. The mixture from each cylinder 58 is used to flush each sensing cavity until the appropriate zero level measurement is obtained.

The air current cavity 60 in its initial state is compressed. Through an initial expansion action the bellows, the gas member is drawn sequentially through each of the plurality sensing cavities and into the air current cavity 60. The bellows will move the gas sample mixture back and forth between all sequential cavities 50, 60 through the expansion/contraction action of the bellows. The purpose of the filters 52 is to slowly eliminate one or more compounds from the gas mixture (i.e., methanol, etc). In this way, through comparative time measurements from chamber to chamber, an operator can develop pattern recognition algorithms that become compound selective even when the smell sensor arrays contain a plurality of non-selective gas sensors. Each chamber (nasal cavity plus lung cavity) contains at least one identical smell sensor array and all chambers contain identical arrays. Odors are composed of many compounds. Non-selective sensors respond to the odor as a whole with little distinction between compounds. In order, to allow for quantitative compound measurements, such as concentration measurements, and for better classification of the odors, it is beneficial to filter unwanted compounds from each gas sample. Moreover, in order to detect the presence of specific compounds that have low concentrations within a given gas sample, it is beneficial to filter the high concentration compounds. Similarly, some compounds (specifically in spirits) present very high concentrations in comparison to other compounds and it is beneficial to filter the high concentration compounds to be able to better analyze the presence and effect of the lower concentration compound to the gas sample's quality. So too, in order to protect the sensors from high concentration compounds and still be able to perform qualitative and quantitative measurements it is beneficial to filter the high concentration compounds from each gas sample. By utilizing multiple sequential sensing cavities 50, with filters 52 separating each such cavity allows for stage selective filtering of more than one compound from a given gas sample. Since the filtering is not instantaneous within each cavity 50, transient and steady state measurements from the sensor arrays 54 can be recorded and analyzed. By employing the FIG. 3 embodiment, one skilled in the art of pattern recognition algorithms will be able to readily exploit the filtering results to better qualify quantitatively and qualitatively each gas sample.

As shown in FIG. 3, the sensing cavities 50 are separated from the air current cavity 60 by a membrane filter 52, such as a blank filter or a carbon filter. Further, as described above, the air current cavity contains an at least one sensor array 62. When the apparatus 2 is initially put into use, the gas sample mixture will be fed into the first sequential sensing cavity. Through the back and forth action of the air current assembly 20 the air mixture will be circulated through all sensing cavities and through ail of the filters. The air current cavity 60, being the innermost cavity of the apparatus 2 cavity (and due to the filtering action), will contain a gas sample mixture of the highest level of purity. The transient and steady state measurements from all sequential sensing cavities 50 will be recorded and analyzed using the appropriate algorithm. The filtering action is not instantaneous and as a result, on commencement of operation, the sensors responses present transient signals. The circulation of the gas sample mixture through all of the sensing cavities will continue until steady state responses from all sensors in all cavities has been recorded. Combining the transient and steady state responses in specialized odor classifiers can enhance the performance of the odor classifier. Specifically, better odor selectivity and classification based on quantity and quality qualifiers can be achieved.

While one or more embodiments of this invention have been illustrated in the accompanying drawings and described above, it will be evident to those skilled in the art that changes and modifications can be made therein without departing from the essence of this invention. All such modifications are believed to be within the sphere and scope of the invention as defined by the claims appended hereto.

What is claimed is:

1. An apparatus for measuring properties of a liquid or gas sample, the apparatus comprising:
an interior cavity for holding a volume of the sample;
a port disposed on an outer wall of the interior cavity, the port for enabling deposit of the sample into the interior cavity;
an air current assembly operatively connected to the interior cavity, the air current assembly comprising an expandable body portion for producing an air flow within the interior cavity, to uniformly distribute the sample, by axial expansion and contraction of the body portion in response to a load applied to an axial end thereof;
an at least one sensor array disposed within the interior cavity, the at least one sensor array for measuring properties of the sample and producing an output; and
a processor in signal communication with each of the at least one sensor arrays, the processor for receiving the output and controlling operation of each of the at least one sensor arrays.

2. The apparatus of claim 1 wherein the interior cavity is an expansible cavity capable of expanding and contracting in response to the expansion and contraction action of the air current assembly.

3. The apparatus of claim 1 wherein the interior cavity is itself comprised of a first cavity housing the sensor array and a second cavity housing the air current assembly.

4. The apparatus of claim 3 wherein the first cavity feeds into the second cavity.

5. The apparatus of claim 1 wherein the body portion of the sir current assembly takes the form of a bellows having flexible side walls.

6. The apparatus of claim 1 wherein the axial end of the body portion of the air current assembly terminates in a back plate.

7. The apparatus of claim 6 wherein an at least one fan is attached to the back plate, the at least one fan operable to promote the equal distribution of the sample throughout the interior cavity.

8. The apparatus of claim 6 further comprising an at least one stabilizing rod fitted in sliding engagement with the back plate, wherein the back plate is supported by the at least one stabilizing rod as the back plate moves back in forth when a load is applied to the axial end of the body portion.

9. The apparatus of claim 1 wherein there are two sensor arrays.

10. The apparatus of claim 9 further comprising a separator depending from a wall of the interior cavity and positioned between the two sensor arrays 28, the separator for enabling comparative measurements of the sample by each of the two sensor arrays without interference.

11. The apparatus of claim 1 further comprising an at least one valve controlled inlet tube in communication with the interior cavity and terminating in an air source for directing air from the air source into the interior cavity.

12. The apparatus of claim 1 further comprising a motor for applying a load to the axial end of the air current assembly.

13. The apparatus of claim 12 wherein the motor is a stepper motor.

14. The apparatus of claim 13 further comprising a threaded shaft 27 and protrudes through the back plate 24, wherein the back plate will move back and forth axially within the second cavity 18 when a load is cyclically applied to and removed from the axial end of the back plate 24 by operation of the stepper motor 26, which results in the axial expansion and contraction of the bellows.

15. The apparatus of claim 1 further comprising a sample chamber disposed in sealing engagement with the interior cavity via a port positioned between the sample chamber and the interior cavity, the sample chamber for holding a volume of the sample prior to transport into the interior cavity.

16. The apparatus of claim 2 wherein the sample chamber further comprises a heater for heating the sample prior to transport into the interior cavity.

17. The apparatus of claim 1 wherein the sample chamber is detachable from the apparatus.

18. An apparatus for measuring properties of a liquid or gas sample, the apparatus comprising:
a plurality of sensing cavities for holding a volume of the sample, each of the sensing cavities comprising an at least one sensor array for measuring properties of the sample and producing an output, wherein each of the sensing cavities is in fluid communication with each of the other sensing cavities;
an at least one access door disposed on an outer wall of at least one of the sensing cavities, the access door for enabling deposit of the sample into the interior cavity;
a membrane filter disposed between each of the at least one sensing cavities, each membrane filter for selectively filtering one or more compounds from the sample;
an air current assembly operatively connected to the interior cavity, the air current assembly comprising an expandable hotly portion for producing an air flow within the interior cavity, to uniformly distribute the sample, by axial expansion and contraction of the body portion in response to a load applied to an axial end thereof; and
a processor in signal communication with each of the at least one sensor arrays, the processor for receiving the output and controlling operation of each of the at least one sensor arrays.
